(19) United States
(12) Patent Application Publication
(10) Pub. No.: US 2008/0127274 A1
(43) Pub. Date: May 29, 2008

(54) Information processing apparatus

(76) Inventors: Kazuyo Kuroda, Tokyo (JP); Noriyuki Hirayama, Tokyo (JP); Tetsuo Hatakeyama, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/810,556

(22) Filed: Jun. 6, 2007

(30) Foreign Application Priority Data
Nov. 28, 2006 (JP) 2006-320623

(51) Int. Cl. G06F 3/00

(52) U.S. Cl. 725/54

(57) ABSTRACT

According to one embodiment, an information processing apparatus comprising: a data acquisition unit that acquires contents data encrypted by a first encryption process; and a data processing unit that acquires and processes the contents data from the data acquisition unit; wherein the data acquisition unit is connectable to an IC card that includes decryption data for decrypting the contents data encrypted by the first encryption process; the data acquisition unit includes a plurality of data processor each decrypting the contents data encrypted by a first encryption process using the decryption data through a communication with the IC card; and an arbitration unit exclusively give one of the plurality of data processor a permission for establishment of the communication with the IC card.

### CROSS-REFERENCE TO RELATED APPLICATIONS

This application is based upon and claims the benefit of priority from Japanese Patent Application No. 2006-320623, filed Nov. 28, 2006, the entire contents of which are incorporated herein by reference.

### BACKGROUND

1. Field

One embodiment of the invention relates to an information processing apparatus configured to acquire encrypted contents data and to perform processing (e.g., reproduction, recording, and edition) on the acquired data.

2. Description of the Related Art

Contents data used in terrestrial digital broadcasting are broadcast by being encrypted to enable a conditional reception. A digital broadcast receiver having an IC card, a CPU, a plurality of systems, each of which includes a tuner and a descrambling portion, is known as an apparatus for reproducing such contents data (see JP-A-11-155139).

In this digital broadcast receiver, the encrypted contents data are demodulated by the tuners. Subsequently, the demodulated data are decrypted by the descrambling portions according to decryption data (e.g., key data for decryption) processed by the IC card. At that time, the CPU controls the IC card so that the decryption data are sequentially output to the descrambling portions, respectively. Consequently, a plurality of pieces of contents data can be simultaneously decrypted using a single IC card.

However, in a case where the aforementioned technique is applied a computer system, such as a personal computer, having an open architecture including a user access bus, signals for controlling an IC card to sequentially output decryption data to descrambling portions are transmitted from a CPU. Consequently, the signals may be hacked through the user access bus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram illustrating a system configuration of an embodiment of an information processing apparatus according to the invention.

FIG. 2 is an exemplary diagram illustrating a copyright unit status management table.

FIG. 3 is an exemplary diagram illustrating a command management table.

FIG. 4 is an exemplary diagram illustrating a key information management table.

FIG. 5 is an exemplary flowchart illustrating the overall process performed by a copyright protection unit.

FIG. 6 is an exemplary flowchart illustrating initialization processing illustrated in FIG. 5.

FIG. 7 is an exemplary flowchart illustrating command processing illustrated in FIG. 5.

FIG. 8 is an exemplary flowchart illustrating IC card processing illustrated in FIG. 7.

FIG. 9 is another exemplary flowchart illustrating the IC card processing illustrated in FIG. 7.

FIG. 10 is an exemplary flowchart illustrating stream processing illustrated in FIG. 5.

### DETAILED DESCRIPTION

Various embodiments according to the invention will be described hereinafter with reference to the accompanying drawings. In general, according to one embodiment of the invention, an information processing apparatus comprising: a data acquisition unit that acquires contents data encrypted by a first encryption process; and a data processing unit that acquires and processes the contents data from the data acquisition unit; wherein the data acquisition unit is connectable to an IC card that includes decryption data for decrypting the contents data encrypted by the first encryption process; the data acquisition unit includes a plurality of data processor each decrypting the contents data encrypted by a first encryption process using the decryption data through a communication with the IC card; and an arbitration unit exclusively give one of the plurality of data processor a permission for establishment of the communication with the IC card.

Hereinafter, a preferred embodiment of the invention is described in detail with reference to the accompanying drawings.

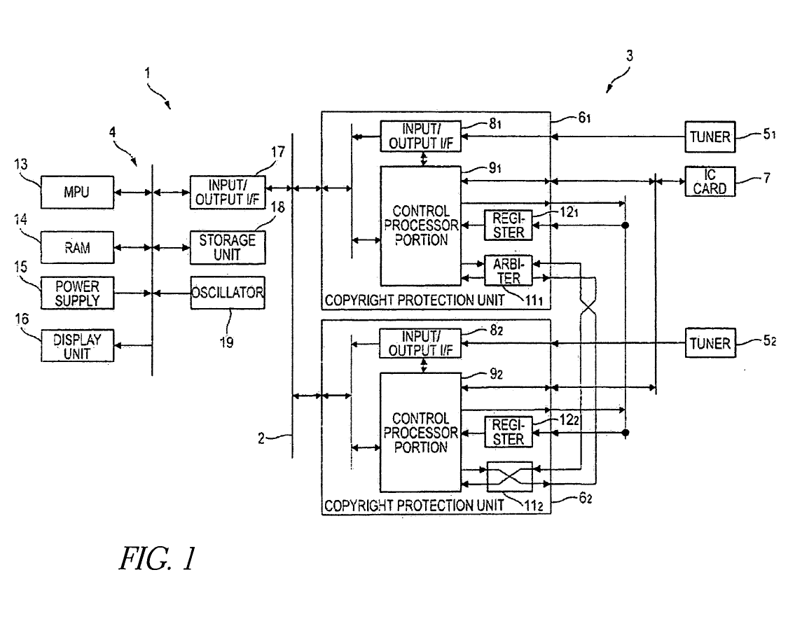

As shown in FIG. 1, an information processing apparatus 1 is a personal computer having a data acquisition portion (corresponding to the data acquisition means) 3 and a data processing portion (corresponding to the data processing means) 4, which are connected to each other through a user access bus 2. The user access bus 2 is a digital connection interface bus through which a user can easily take out signals. Examples of the user access bus 2 are a PCI (Peripheral Component Interconnect) bus, an IDE (Integrated Drive Electronics) bus, and a SCSI (Small Computer System Interface) bus. The data acquisition portion 3 acquires contents data (represented by broadcast waves) that are encrypted (hereunder referred to as “scrambled”) and are used in terrestrial digital broadcasting, and performs various processing thereon. The data processing portion 4 acquires contents data from the data acquisition portion 3 through the user access bus 2, and performs various processing, such as reproduction, recording, and editing, on the contents data.

The data acquisition portion 3 has tuners 5₁ and 5₂ configured to receive the scrambled contents data by antennas and to demodulate the received data, copyright protection units 6₁ and 6₂ configured to acquire the demodulated contents data and to perform various processing on the acquired data, and an IC card 7 configured to process decryption data for decryption (hereunder referred to as “descrambling”) of the contents data. The tuner 5₁ is used by the copyright protection unit 6₁, while the tuner 5₂ is used by the copyright protection unit 6₂. The IC card 7 is shared by and is controlled by both of the copyright protection units 6₁ and 6₂.

The copyright protection unit 6₁ has an input/output interface 8₁ configured to exchange information with an external apparatus, a control processor portion (corresponding to the data processing portion) 9₁ configured to execute a copyright protection unit control program and to control the entire copyright protection unit 6₁, an arbiter (corresponding to the arbitration portion) 11₁ configured to perform the exclusive control of the IC card 7, and the register (corresponding to the information sharing portion) 12₁ used to hold a status.

Similarly to the copyright protection unit 6₁, the copyright protection unit 6₂ has an input/output interface 8₂, a control processor portion (corresponding to the data processing portion) 9₂, an arbiter (corresponding to the arbitration portion) 11₂, and the register (corresponding to the information sharing portion) 12₂. Incidentally, the copyright protection unit 6₂ differs from the copyright protection unit 6₁, in which the arbiter 11₁ is enabled, in that the arbiter 11₂ is disabled.

The control processor portion 9₁ performs the descrambling of the contents data demodulated by the tuner 5₁ using the decryption data processed by the IC card 7. Also, the control processor portion 9₁ performs copyright protection processing to thereby perform encryption (hereunder referred to “local encryption”) on the descrambled contents data. The control processor portion 92 performs processing on the contents data demodulated by the tuner 52, which is similar to the processing performed by the control processor portion 9₁.

The arbiter 11₁ exclusively (i.e., selectively) gives each of the plurality of control processor portions 9₁ and 9₂ a permission for establishment of communication with the IC card 7. That is, the arbiter 11₁ arbitrates communication requests from both the to the IC card 7, and gives only one of the control processor portions 9₁ and 9₂ a permission for communication with the IC card 7. Each of the control processor portions 9₁ and 9₂ transmits a part of broadcast data to the IC card 7, and receives a response from the IC card 7 to thereby use the descrambling of the contents data.

The registers 12₁ and 12₂ share shared IC card information (communication establishment information) for establishment of communication with the IC card 7 by each of the control processor portions 9₁ and 9₂. The control processor portion 9₁ reads the shared IC card information from the corresponding register 12₁, and establishes communication with the IC card 7. Then, the control processor portion 9₁ updates the shared IC card information shared by the registers 12₁ and 12₂. On the other hand, the control processor portion 9₂ reads the shared IC card information from the corresponding register 12₂, and establishes communication with the IC card 7. Then, the control processor portion 9₁ updates the shared IC card information shared by the registers 12₁ and 12₂. That is, the shared IC card information shared by the registers 12₁ and 12₂ are simultaneously updated. Consequently, the copyright protection units 6₁ and 6₂ can share the shared IC card information.

The data processing portion 4 has an MPU 13 configured to control the entire system of the information processing apparatus 1, a RAM 14 used when the MPU 13 executes programs, such as a host application program, a power supply 15 configured to supply electric power, a display unit 16 configured to display necessary information representing, for example, a control result, an input/output interface 17 configured to exchange information with an external apparatus, a storage unit 18 configured to store programs and data, and an oscillator 19 configured to set a system time, and to perform synchronization operations. The data processing portion 4 has the function of performing decryption (hereunder referred to as “local decryption”) of contents data, the local encryption of which has been performed by the control processor portions 91 and 92, and also has the functions of reproducing, recording, and editing the decrypted contents data.

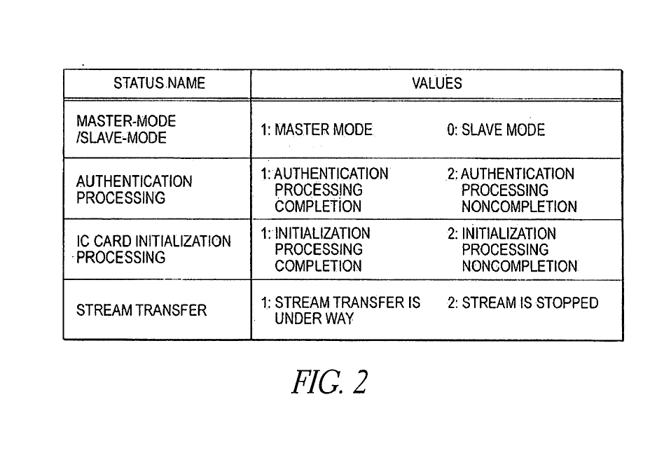

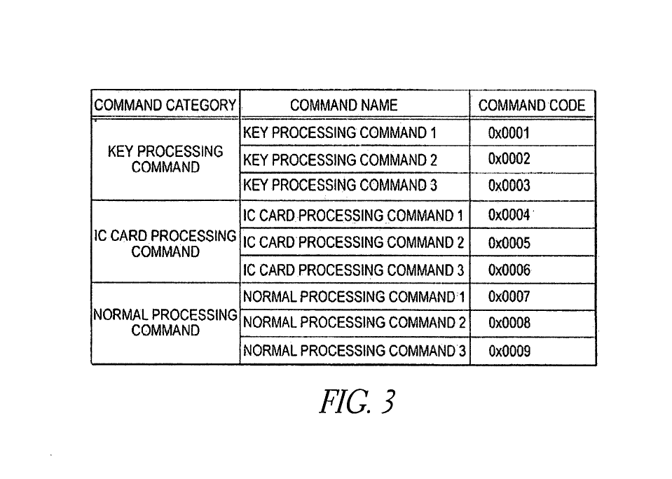

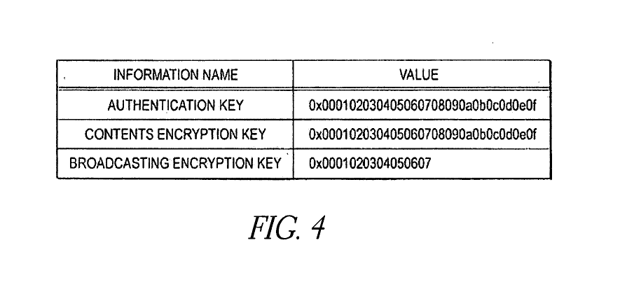

FIG. 2 is a diagram illustrating a copyright protection unit status management table. FIG. 3 is a diagram illustrating a command management table. FIG. 4 is a diagram illustrating a key information management table. These tables are stored in each of the control processor portion 9₁ of the copyright protection unit 6₁ and the control processor portion 9₂ of the copyright protection unit 6₂.

As illustrated in FIG. 2, the item “MASTER-MODE/SLAVE-MODE” indicates which of the master mode and the slave mode the current mode of each of the copyright protection units 6₁ and 6₂. An initial value of this item represents the slave mode. The item “AUTHENTICATION” indicates whether the authentication between the host application program and each of the copyright protection units 6₁ and 6₂ is completed. An initial value of this item indicates that the authentication processing is not completed. The item “IC CARD INITIALIZATION PROCESSING” indicates whether the initialization of the IC card 7 is completed, that is, the IC card 7 is in an available state. An initial value of this item indicates that the initialization processing is not completed. The item “STREAM TRANSFER” indicates whether the contents data is being transferred as stream data. An initial value of this item represents a state in which the stream is stopped.

As illustrated in FIG. 3, the item “COMMAND CATEGORY” represents commands roughly classified. The item “COMMAND NAME” represents the names of the commands. The item “COMMAND CODE” is a numerical value item representing a numerical value identifying the command. The command categories include a key processing command, an IC card processing command, and a normal processing command. The key processing command is used for establishing key information to be used when the host application program performs encryption processing on the contents data. The IC card processing command is used for performing communication with the IC card 7. The normal processing command is used for performing authentication processing, checking a state of each of the copyright protection units 6₁ and 6₂, and changing the state thereof.

As illustrated in FIG. 4, information established in an authentication process performed between the host application program and each of the copyright protection units 6₁ and 6₂ is stored in the field of the item “AUTHENTICATION KEY”. Key information used for the local encryption of the contents data is stored in the field of the item “CONTENTS ENCRYPTION KEY”. Key information for descrambling of contents data is stored in the field of the item “BROADCASING ENCRYPTION KEY”.

Next, an operation of the information processing apparatus 1 is described below.

The host application program is a module for controlling the entire system of the information processing apparatus 1 and is stored in the storage unit 18, and runs in the MPU 13. The copyright protection unit control program is a module adapted to control each of the copyright protection units 6₁ and 6₂. The copyright protection unit control program is stored and runs in each of the control processor portions 9₁ and 9₂. A copyright protection unit control program running in a master mode is stored in the copyright protection unit 6₁. A copyright protection unit control program running in a slave mode is stored in the copyright protection unit 6₂.

The host application program and each of the copyright protection units 6₁ and 6₂ perform authentication processing according to an instruction issued by the host application program. Thus, the validity of a person trying to access is checked. Also, an authentication key used for bus encryption/decryption of contents data is established. Two stream contents-data input from the antennas are demodulated by the tuners 5₁ and 5₂, respectively. Each of the copyright protection units 6₁ and 6₂ communicates with the IC card 7 while performing an exclusive control operation using the demodulated contents data. Thus, a broadcasting encryption key (i.e., decryption data) used for descrambling of the contents data is established. Then, the descrambling of the contents data is performed using the broadcasting encryption key. Subsequently, the local encryption of the contents data is performed using the contents encryption key. Then, resultant data is transferred to the user access bus 2.

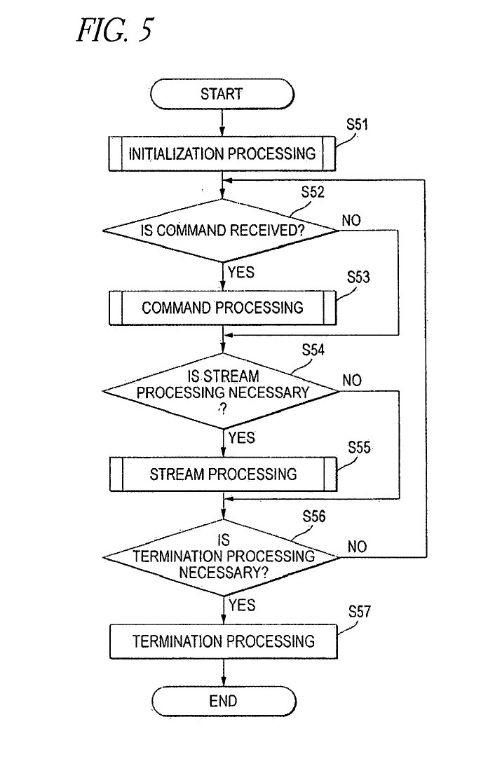

The overall processing of the copyright protection unit 6₁ (mainly the function of the control processor portion 9₁) is described below with reference to FIG. 5. Incidentally, the copyright protection unit 6₂ performs overall processing (mainly the function of the control processor portion 9₂), which is similar to that performed by the copyright protection unit 6₁.

At a system start, initialization processing is performed in step S51. Upon completion of the initialization processing, the copyright protection unit 6₁ checks in step S52 whether a command is received from the host application program. Consequently, if the copyright protection unit 6₁ has received a command, the copyright protection unit 6₁ performs command processing in step S53. Conversely, if the copyright protection unit 6₁ has received no command, the copyright protection unit 6₁ advances to the next step, without performing the command processing.

Subsequently, in step S54, the copyright protection unit 6₁ checks the item “STREAM TRANSFER” of the copyright protection unit status management table (see FIG. 2) to determine whether stream processing is needed. Consequently, if the stream processing is needed, the copyright protection unit 6₁ performs the stream processing in step S55. In this case, the stream processing is simultaneously performed even while the command processing is performed. Conversely, if the stream processing is unnecessary, the copyright protection unit 6₁ proceeds to the next step, without performing the stream processing.

Subsequently, in step S56, the copyright protection unit 6₁ checks whether the termination processing, such as turning-off of a system power supply, is needed. Consequently, if the termination processing is needed, the copyright protection unit 6₁ performs the termination processing and terminates the system in step S57. Conversely, if the termination processing is unnecessary, the copyright protection unit 6₁ returns to step S52, in which the copyright protection unit 6₁ waits for receiving a command.

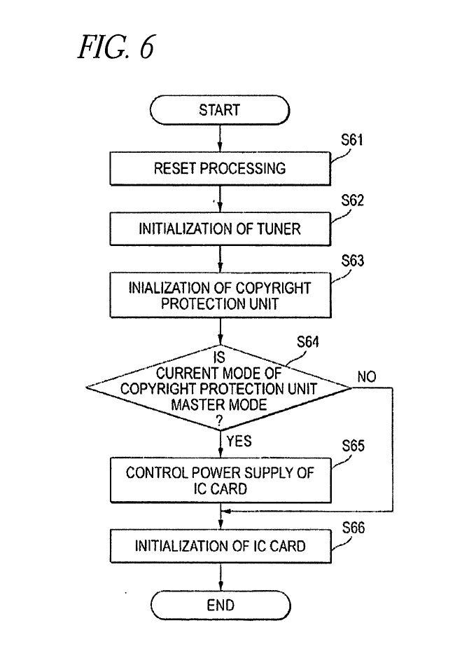

The aforementioned initialization processing in step S51 shown in FIG. 5 is described below with reference to FIG. 6.

When the power supply is turned on, the reset processing of the entire system of the information processing apparatus 1 is performed in step S61. Then, the initialization processing of the tuners 5₁ and 5₂ is performed in step S62, so that an initial state needed for channel selection processing and demodulation processing is set. Subsequently, in step S63, the initialization of the copyright protection unit 6₁ and the copyright protection unit 6₂ is performed. More specifically, the copyright protection unit status management table (see FIG. 2) is set in an initial state. The copyright protection unit 6₁ is in a master mode. Thus, the value of the item “MASTER-MODE/SLAVE-MODE” is set to “1: MASTER MODE”. On the other hand, the copyright protection unit 6₂ is in a slave mode. Thus, the value of the item “MASTER-MODE/SLAVE-MODE” is set to “0: SLAVE MODE”. Also, the key information management table (see FIG. 4) is initialized. Additionally, initial setting needed for the encryption/decryption of the contents data is performed.

Subsequently, in step S64, each of the copyright protection units 6₁ and 6₂ checks the values corresponding to the item “MASTER-MODE/SLAVE-MODE” of the copyright protection unit status management table (see FIG. 2) to determine whether the current mode is a master mode. Consequently, if the current mode is a master mode, electric power is supplied to the IC card 7 in step S65. Conversely, if the current mode is a slave mode, each of the copyright protection units 6₁ and 6₂ proceeds to the next step, without controlling the power supply for the IC card 7. Next, in step S66, each of the copyright protection units 6₁ and 6₂ performs the initialization processing of the IC card 7, so that the IC card 7 is set in a state in which the IC card 7 can receive a command. If the initialization processing has successfully been performed, each of the copyright protection units 6₁ and 6₂ sets the value “1: INITIALIZATION PROCESSING IS COMPLETED” in the field of the “IC CARD INITIALIZATION PROCESSING” status in the copyright protection unit status management table (see FIG. 2).

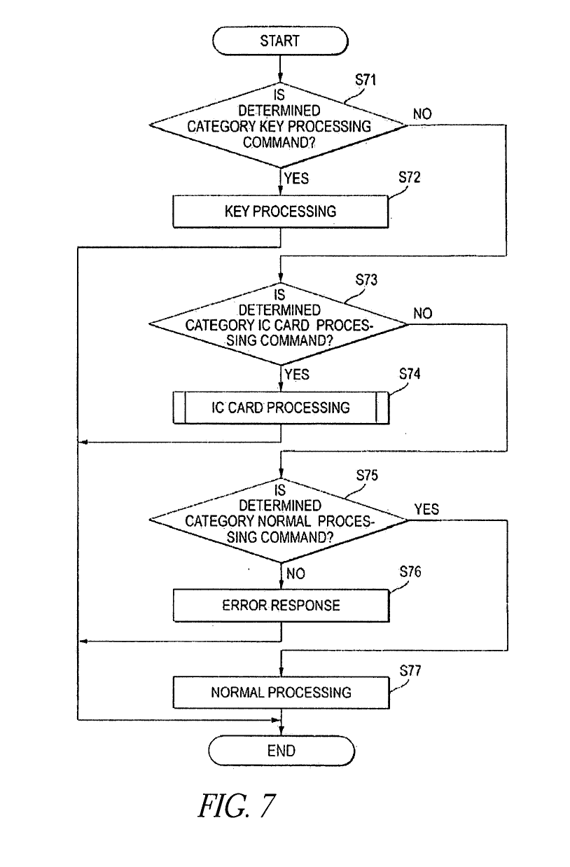

The aforementioned command processing in step S53 shown in FIG. 5 is described below with reference to FIG. 7.

Each of the copyright protection units 61 and 62 analyzes the received command and refer to the items “COMMAND CODE” of the command management table (see FIG. 3). Then, each of the copyright protection units 61 and 62 determine the command name corresponding to the command code, which is matched with the received command, as the name of the received command. Also, each of the copyright protection units 61 and 62 determines the command category corresponding to the name of the received command. Subsequently, each of the copyright protection units 6₁ and 6₂ determines in step S71 whether the determined command category is the key processing command. Consequently, if the determined command category is the key processing command, each of the copyright protection units 6₁ and 6₂ performs the key processing in step S72.

Conversely, if the determined command category is not the key processing command, each of the copyright protection units 6₁ and 6₂ determines in step S73 whether the determined command category is the IC card processing command. If the determined command category is the IC card processing command, each of the copyright protection units 6₁ and 6₂ performs the IC card processing in step S74 while performing an exclusive control operation.

Conversely, if the determined command category is not the IC card processing command, each of the copyright protection units 6₁ and 6₂ determines in step S75 whether the determined command category is the normal processing command. Consequently, if the determined command category is the normal processing command, each of the copyright protection units 6₁ and 6₂ performs the normal processing in step S76.

In a case where the authentication processing between the host application program and each of the copyright protection units 6₁ and 6₂ is successful as a result of this process, each of the copyright protection units 6₁ and 6₂ establishes an authentication key and causes a key information management table (see FIG. 4) to store the authentication key in the field of the item “AUTHENTICATION KEY”. Also, each of the copyright protection units 6₁ and 6₂ sets the value of the authentication processing status of the copyright protection unit status management table (see FIG. 2) to the value “1: AUTHENTICATION PROCESSING COMPLETION”. Also, each of the copyright protection units 6₁ and 6₂ processes the contents encryption key and causes the key information management table (see FIG. 4) to store the processed contents encryption key in the field of the item “CONTENTS ENCRYPTION KEY”. When starting a stream output, each of the copyright protection units 6₁ and 6₂ sets the item “STREAM TRANSFER” of the copyright protection unit management table (see FIG. 2) to the value “1: STREAM TRANSFER IS UNDER WAY”. When stopping the stream output, each of the copyright protection units 6₁ and 6₂ sets the item “STREAM TRANSFER” of the copyright protection unit management table (see FIG. 2) to the value “0: STREAM IS STOPPED”.

Meanwhile, if the determined command category is not the normal processing command, the copyright protection units 6₁ and 6₂ returns an error response, which indicates that the determined command category is not supported, in step S77.

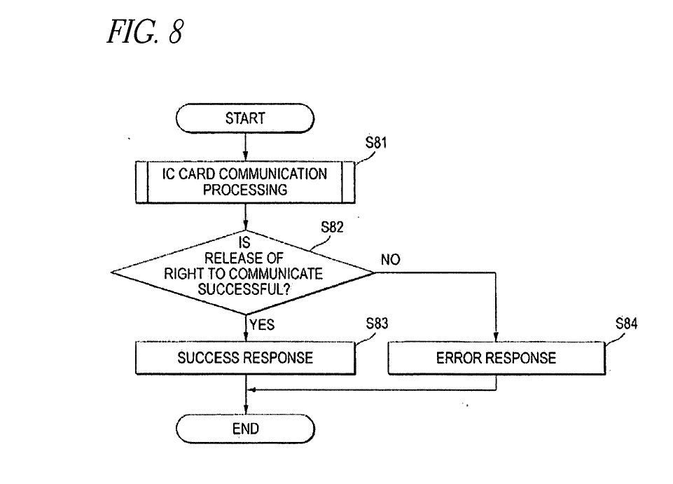

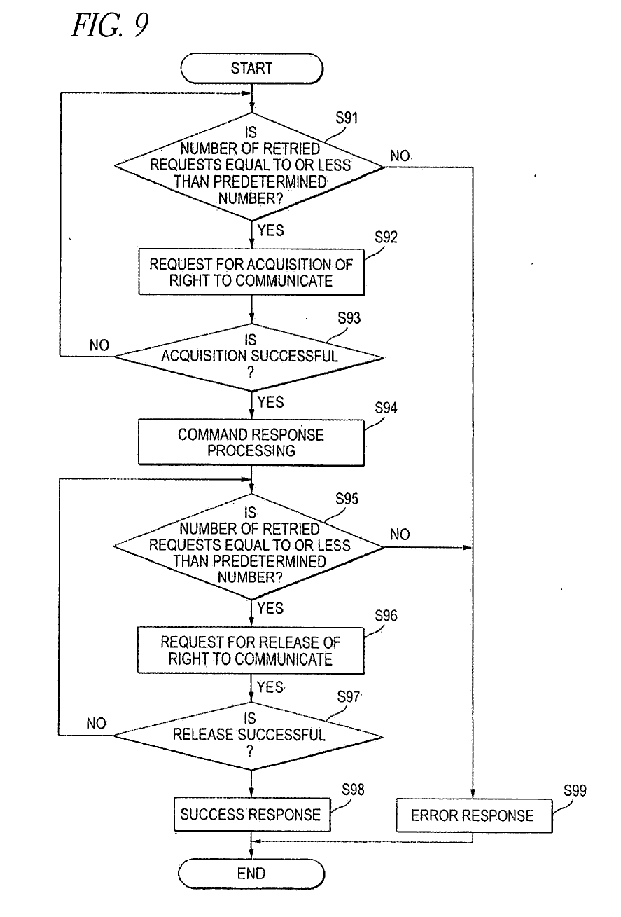

The aforementioned IC card processing in step S74 shown in FIG. 7 is described below with reference to FIGS. 8 and 9. Incidentally, the IC card processing performed by the copyright protection unit 6₂ differs from that performed by the copy right protection unit 6₁ in that the copyright protection unit 6₂ reads and writes the shared IC card information from and to the register 12₂, while the copyright protection unit 6₁ reads and writes the shared IC card information from and to the register 12₁.

In step S81, the copyright protection unit 6₁ performs the IC card communication processing. In step S91, the copyright protection unit 6₁ checks whether the number of times of retries of requests for acquisition of a right to communicate with the IC card 7. Consequently, if the number of times of retries of requests for acquisition of the right to communicate with the IC card 7 is equal to or less than 1000, the copyright protection unit 6₁ makes a request to an arbiter 11₁ for acquisition of the right to communicate with the IC card 7, in step S92. Meanwhile, in a case where the copyright protection unit 6₂ has a monopoly of the right to communicate with the IC card 7, and where the number of times of retries of requests for acquisition of the right to communicate with the IC card 7 exceeds 1000, the copyright protection unit 6₁ returns an IC card communication processing error response to the host application program in steps S99 and S84. Then, the copyright protection unit 6₁ terminates the processing.

Subsequently, if the copyright protection unit 6₁ is successful in acquisition of the right to communicate with the IC card 7 in step S93, the copyright protection unit 6₂ does not use the IC card 7. Thus, the copyright protection unit 6₁ can use the IC card 7. Accordingly, the copyright protection unit 6₁ reads the shared IC card information from the register 12₁. The copyright protection unit 6₁ issues a command to the IC card 7 using the read shared-IC-card information. Subsequently, the copyright protection unit 6₁ receives a response from the IC card 7. Then, the copyright protection unit 6₁ updates the shared IC card information stored in each of the registers 12₁ and 12₂ using a result of receiving the response.

Meanwhile, in a case where the copyright protection unit 6₂ is communicating with the IC card 7, and where the copyright protection unit 6₁ fails in acquisition of the right to communicate with the IC card 7 in step S93, the copyright protection unit 6₁ adds 1 to the number of times of retries of requests for acquisition of the right to communicate with the IC card 7. Then, the copyright protection unit 6₁ returns to step S91 in which the copyright protection unit 6₁ checks whether the number of times of retries of requests for acquisition of the right to communicate with the IC card 7.

After updating the shared IC card information, the copyright protection unit 6₁ checks the number of times of retries of requests for release of the right to communicate with the IC card 7 in step S95. Consequently, if the number of times of retries of requests for release of the right to communicate with the IC card 7 is equal to or less than 1000, the copyright protection unit 6₁ makes a request to the arbiter 11₁ for release of the right to communicate with the IC card 7, in step S96. Meanwhile, in a case where the number of times of retries of requests for release of the right to communicate with the IC card 7 exceeds 1000, the copyright protection unit 6₁ returns an IC card communication processing error response to the host application program in steps S99 and S84. Then, the copyright protection unit 6₁ terminates the processing.

Subsequently, if the copyright protection unit 6₁ is successful in release of the right to communicate with the IC card 7 in steps S97 and S82, the copyright protection unit 6₁ returns a success response to the host application program in steps S98 and S83. Then, the copyright protection unit 6₁ terminates the processing. Conversely, in a case where the copyright protection unit 6₁ fails in release of the right to communicate with the IC card 7 in step S97, the copyright protection unit 6₁ adds 1 to the number of times of retries of requests for release of the right to communicate with the IC card 7. Then, the copyright protection unit 6₁ returns to step S95 in which the copyright protection unit 6₁ checks whether the number of times of retries of requests for release of the right to communicate with the IC card 7.

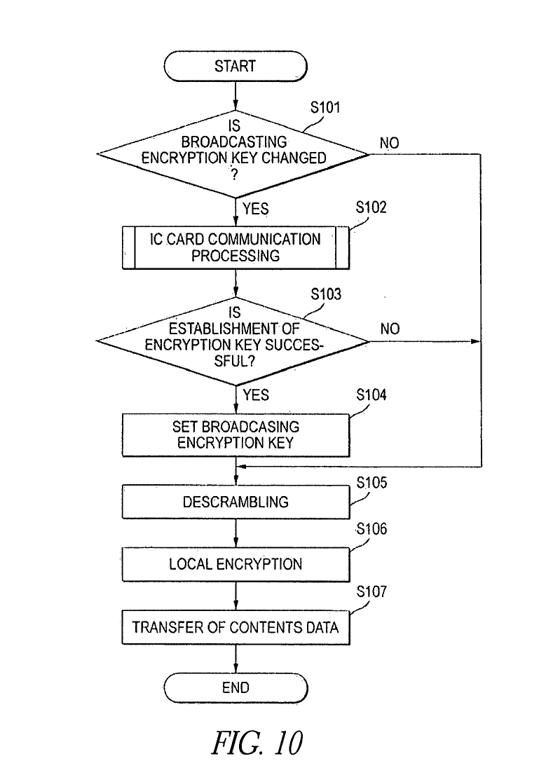

The aforementioned stream processing in step S55 shown in FIG. 5 is described below with reference to FIG. 10. The stream processing by the copyright protection unit 6₁ is performed simultaneously with the stream processing by the copyright protection unit 6₂. Incidentally, the stream processing performed by the copyright protection unit 6₂ differs from that performed by the copyright protection unit 6₁ in that the contents data is demodulated by the tuner 5₂ in the former stream processing while the contents data is demodulated by the tuner 5₁ in the latter stream processing.

The contents data input from the antennas is demodulated by the tuner 5₁. The copyright protection unit 6₁ performs sequential analysis on the demodulated contents data. When original data representing the broadcasting encryption key is changed in step S101, the copyright protection unit 6₁ performs the IC card communication processing (see FIG. 9) and establishes the broadcasting encryption key, which is used for descrambling of the contents data, in step S102. Then, in step S104, the copyright protection unit 6₁ causes the key information management table (see FIG. 4) to store the established broadcasting encryption key in the field of the item “BROADCASTING ENCRYPTION KEY”.

Subsequently, in step S105, the copyright protection unit 6₁ performs the descrambling of the contents data using the established broadcasting encryption key to thereby obtain a plaintext. Also, in step S106, the copyright protection unit 6₁ performs the local encryption of the plaintext contents-data by referring the item “CONTENTS ENCRYPTION KEY” of the key information management table (see FIG. 4) and using the contents encryption key. Subsequently, the copyright protection unit 6₁ transfers the contents data, which has undergone the local encryption, to the user access bus 2 in step S107. Then, the local encryption of the contents data transferred to the user access bus 2 is performed by the data processing portion 4 to thereby reproduce the contents data.

As described above, in the information processing apparatus 1, the data acquisition portion 3 connected to the data processing portion 4 as a preceding stage of the user access bus 2 includes the control processor portions 9₁ and 9₂ and the arbiter 11₁. Thus, the communication between the arbiter 11₁ and each of the control processor portions 9₁ and 9₂ can be prevented from being hacked through the user access bus 2. Additionally, the arbiter 11₁ exclusively gives each of the plurality of control processor portions 9₁ and 9₂ a permission for establishment of communication with the IC card 7. Thus, the descrambling of the two scrambled stream contents-data can be simultaneously performed by the single IC card 7. Consequently, the processing (e.g., reproduction, recording, and editing) of the contents data can be achieved.

Also, in the information processing apparatus 1, each of the control processor portions 9₁ and 9₂ performs the local encryption of the descrambled contents data and transfers resultant data to the user access bus 2. Accordingly, the plaintext contents-data can be prevented from being hacked through the user access bus 2.

Further, in the information processing apparatus 1, the copyright protection unit 6₁ (or 6₂) performs communication with the IC card 7 after confirming that the copyright protection unit 6₂ (or 6₁) does not use the IC card 7. Consequently, occurrence of IC card processing contention can be prevented.

Also, in the information processing apparatus 1, the control processor portion 9₁ in the master mode controls the power supply for the IC card 7. Thus, a processing load on the control processor portion 9₂ in the slave mode can be reduced.

Additionally, in the information processing apparatus 1, the registers 12₁ and 12₂ share the shared IC card information used by each of the control processor portions 9₁ and 9₂ to establish communication with the IC card 7. Further, each of the control processor portions 9₁ and 9₂ reads the shared IC card information from an associated one of the registers 12₁ and 12₂ and establishes the communication with the IC card 7. Then, the shared IC card information, which is shared by the registers 12₁ and 12₂, is updated. Consequently, after the control processor portion 9₂ (or 9₁) issues a command to the IC card 7, the control processor portion 9₁ (or 9₂) can properly issue a command to the IC card 7.

The present invention is not limited to the aforementioned embodiments. For example, according to the aforementioned embodiment, the copyright protection unit 6₁ is in the master mode, while the copyright protection unit 6₂ is in the slave mode. However, the opposite of a mode setting condition for the copyright protection units 6₁ and 6₂ can be allowed. Additionally, according to the aforementioned embodiment, the information processing apparatus 1 has the two tuners 5₁ and 5₂ and the two copyright protection units 6₁ and 6₂ corresponding to the single IC card 7. However, the information processing apparatus 1 can have three or more tuners and three or more copyright protection units corresponding to a single IC card.

What is claimed is:

1. An information processing apparatus comprising:
a data acquisition unit that acquires contents data encrypted by a first encryption process; and
a data processing unit that acquires and processes the contents data from the data acquisition unit;
wherein the data acquisition unit is connectable to an IC card that includes decryption data for decrypting the contents data encrypted by the first encryption process;
the data acquisition unit includes
a plurality of data processors each decrypting the contents data encrypted by a first encryption process using the decryption data through a communication with the IC card; and
an arbitration unit to exclusively give one of the plurality of data processor a permission for establishment of the communication with the IC card.

2. The information processing apparatus according to claim 1, further comprising: a user access bus that connects the data acquisition unit to the data processing unit;
wherein each of the data processors encrypts the decrypted contents data by a second encryption process; and
the data acquisition unit acquires the contents data encrypted by the second encryption process through the user access bus and decrypts the contents data.

3. The information processing apparatus according to claim 2,
wherein the arbitration unit gives the one of the plurality of data processors the permission for establishment of the communication while the rest of the plurality of data processors does not establish the communication.

4. The information processing apparatus according to claim 3,
wherein one of the plurality of data processors controls a power supply of the IC card.

5. The information processing apparatus according to claim 4,
wherein the data acquisition unit includes a plurality of information sharing units each corresponding to respective one of the plurality of data processors; and
wherein the plurality of information sharing units share communication establishment information for establishing the communication.

6. The information processing apparatus according to claim 5,
wherein each of the plurality of data processors reads the communication establishment information from a corresponding one of the plurality of information sharing units to establish the communication, and updates the communication establishment information.
